(19) United States
(12) Patent Application Publication
(10) Pub. No.: US 2015/0117002 A1
(43) Pub. Date: Apr. 30, 2015

(54) HOLOGRAPHIC ORNAMENT

(71) Applicant: Frank McGough, Weddington, NC (US)

(72) Inventor: Frank McGough, Weddington, NC (US)

(21) Appl. No.: 14/559,340

(22) Filed: Dec. 3, 2014

Related U.S. Application Data
(63) Continuation-in-part of application No. PCT/US2013/045783, filed on Jun. 14, 2013.
(60) Provisional application No. 61/659,621, filed on Jun. 14, 2012.

(51) Int. Cl. G02B 5/32; F21V 23/00; F21V 21/08

(52) U.S. Cl. CPC G02B 5/32; F21V 21/08; F21V 23/001; F21Y 2101/02
USPC 362/236; 362/257; 362/311.13; 362/311.02

(57) ABSTRACT

An ornament includes: a shell (18, 118, 318); a hologram (24, 124, 324) mounted inside the shell (18, 118, 318), the hologram (24, 124, 324) comprising a substrate containing a recorded interference pattern, and having a viewing side (26, 126) and an opposed backside (28, 128); and a light source (30, 130, 330) mounted to the shell (18, 118, 318) and positioned so as to project light onto the hologram (24, 124, 324).

### BACKGROUND OF THE INVENTION

This invention relates generally to decorative ornaments and more particularly to ornaments containing holograms therein.

Various types of ornaments are known and used for decorative purposes, especially for hanging on Christmas trees. One common type of ornament comprises a plurality of lights strung along an electric wire. Another common type is a globe or ball which may be opaque or transparent. Globes are also known that are internally illuminated. Some existing internally-illuminated globes include holographic images, however the image and the illumination are not optimized for the best viewing experience.

Accordingly, there is a need for a lighted ornament that presents a high-quality holographic image.

### BRIEF SUMMARY OF THE INVENTION

This need is addressed by the present invention, which provides an ornament containing a holograph contained in a shell. A light source is positioned in the shell so as to illuminate the holograph from a specific direction.

According to one aspect of the invention, an ornament includes: a shell; a hologram mounted inside the shell, the hologram comprising a substrate containing a recorded interference pattern, and having a viewing side and an opposed backside; and a light source mounted to the shell and positioned so as to project light onto the hologram.

### BRIEF DESCRIPTION OF THE DRAWINGS

The invention may be best understood by reference to the following description taken in conjunction with the accompanying drawing figures in which:

FIG. 1 is a cross-sectional view of a portion of an LED-illuminated string of ornaments constructed according to an aspect of the present invention;

FIG. 2 is a cross-sectional view of a portion of a laser-illuminated string of ornaments constructed according to another aspect of the invention;

FIG. 3 is a perspective view of an ornament constructed according to an aspect of the present invention;

FIG. 4 is a right side elevation view of the ornament of FIG. 3, the left side view being a mirror image thereof;

FIG. 5 is a front elevation view of the ornament of FIG. 3;

FIG. 6 is a rear elevation view of the ornament of FIG. 3;

FIG. 7 is a top plan view of the ornament of FIG. 3;

FIG. 8 is a bottom plan view of the ornament of FIG. 3;

FIG. 9 is a front perspective view of an alternative ornament;

FIG. 10 is a front elevation view of the ornament of FIG. 9;

FIG. 11 is a right side elevation view of the ornament of FIG. 9, the left side view being a mirror image thereof;

FIG. 12 is a rear elevation view of the ornament of FIG. 9;

FIG. 13 is a top plan view of the ornament of FIG. 9;

FIG. 14 is a bottom plan view of the ornament of FIG. 9;

FIG. 15 is a side view of a light housing of the ornament of FIG. 9; and

FIG. 16 is a cross-sectional view of the ornament of FIG. 9.

### DETAILED DESCRIPTION OF THE INVENTION

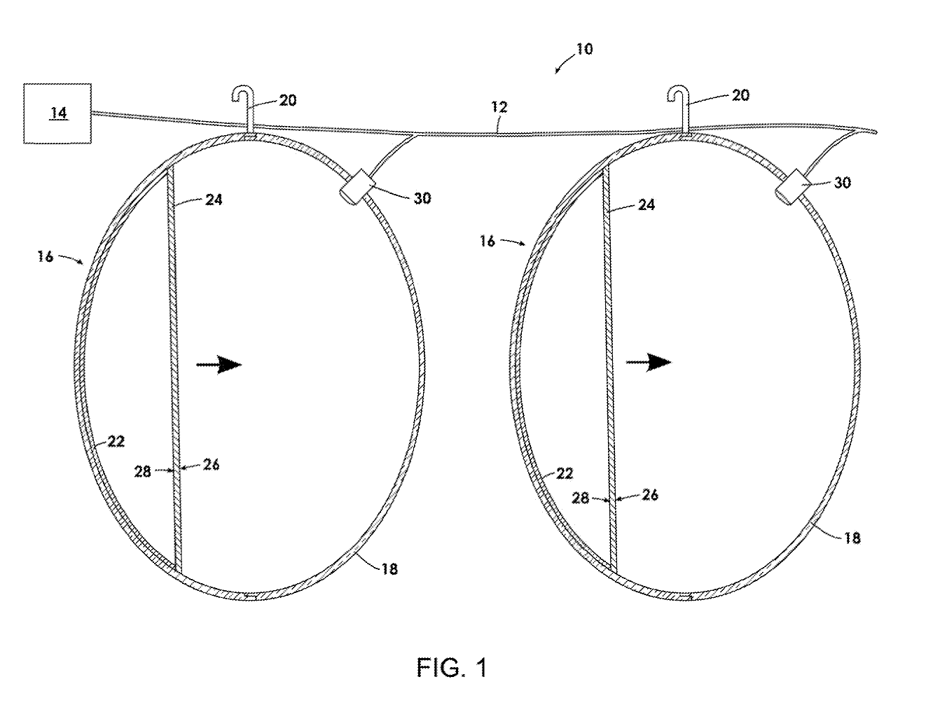

Referring to the drawings wherein identical reference numerals denote the same elements throughout the various views, FIG. 1 depicts an exemplary string 10 of ornaments constructed according to an aspect of the present invention. The string 10 includes a cable 12, a power supply 14, and a plurality of ornaments 16 spaced along the cable 12. Only two ornaments 16 are shown, but it will be understood that the string 10 could include as many ornaments 16 as desired.

The ornament 16 includes a shell 18 that serves to enclose the ornament's working parts. In the illustrated example, the shell 18 is an ellipsoid, however other shapes could be used, for example a sphere or an ovoid. The shell 18 is at least partially transparent or translucent, i.e. at least some portion of the shell 18 is transparent or translucent. Transparent plastic shells constructed in two halves are commercially available and may be used for the shell 18. The shell 18 may be mechanically connected to the cable 12, and is provided with a hook 20 or other suitable structure for hanging the ornament 16.

A portion of the shell 18 is covered, coated, or otherwise configured to block light transmission. In the illustrated example, a portion of the shell 18 is covered with opaque paint 22. The paint 22 or other light-blocking structure may be placed in the interior of the shell 18 in order to assure its durability.

A reflection hologram 24 is mounted inside the shell 18. The hologram 24 has a first side or viewing side 26, indicated by the large arrow, and an opposed backside 28. The hologram 24 is positioned so that the backside 28 faces the paint 22 or other light-blocking structure. The viewing side 26 is thus exposed through the remainder of the shell 18.

The hologram 24 may be mounted inside the shell 18 by any means that will hold it securely in position, for example by using an adhesive, or brackets or tabs.

The hologram 24 comprises a substrate that contains a recorded interference pattern. When viewed under the proper illumination, the interference pattern is visible as an apparent three-dimensional image of the recorded object. The substrate may be film emulsion, a glass plate, or similar material. Methods of making such reflection holograms 24 are known in the art. During creation of the hologram 24, a source object is illuminated with a light source projecting on the source object from a specific direction.

A light source 30 is mounted in the shell 18. In the illustrated example, the light source 30 is a commercially-available white light-emitting diode (“LED”). The light source 30 may incorporate a lens configured to project light onto the hologram 24 as required. The light source 30 is positioned so as to illuminate the hologram 24 from the same direction as the source object was illuminated during creation of the hologram 24, as far as possible.

The power supply 14 is configured to accept a common electric power source, such as 120 Volts AC house current, and to supply the electric power required by the light sources 30, such as 12 Volts DC. A known type of wall-mount power supply may be used for this purpose. The power supply 14 is coupled to each ornament 16 through the cable 12. The ornaments 16 may be wired in series or in parallel as desired. As an alternative to house current, the power supply 14 could be powered by a battery or other electrical storage device.

In operation, the light source 30 of each ornament 16 illuminates the associated hologram 24 with a desired angle and brightness regardless of the placement or orientation of the ornament 16. This allows viewing of the hologram 24 through the shell 18 and presents the user with a high-quality holographic image.

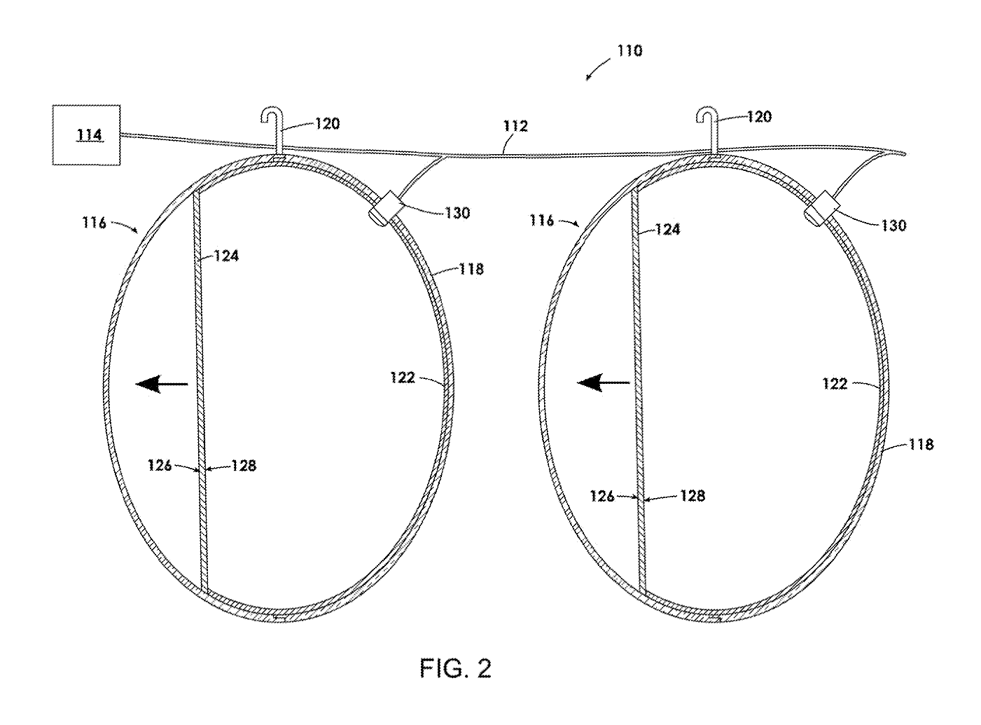

FIG. 2 illustrates another string 110 incorporating an alternative ornament 116. The string 110 includes a cable 112, a power supply 114, and a plurality of ornaments 116. Only two ornaments 116 are shown, but it will be understood that the string 10 could include as many ornaments 116 as desired.

The general construction of the ornament 116 is similar to the ornaments 16 described above, differing only in the type of hologram used in the mounting position of a light source relative to the hologram. The ornament 116 includes a shell 118, hook 120, a hologram 124, and a light source 130.

A transmission hologram 124 is mounted inside the shell 118. The hologram 124 has a first side or viewing side 126, indicated by the large arrow, and an opposed backside 128. The hologram 124 is positioned so that the backside 128 faces a layer of paint 122 or other light-blocking structure, as described above. The viewing side 126 is thus exposed through the remainder of the shell 118.

A light source 130 is mounted in the shell 118, within the area covered by the paint 122 or other light-blocking structure. In the illustrated example, the light source 130 is a laser, such as a commercially-available 650 nm class IIIA red laser. The light source 130 may incorporate a lens configured to project light onto the hologram 124 as required. The light source 130 is positioned so as to illuminate the hologram 124 from the same direction as the source object was illuminated during creation of the hologram 124, as far as possible.

The power supply 114 is configured to accept a common electric power source, such as 120 Volts AC house current, and to supply the electric power required by the light sources 126, such as 3 Volts DC. A known type of wall-mount power supply may be used for this purpose. The power supply 114 is coupled to each ornament 116 through the cable 112. The ornaments 116 may be wired in series or in parallel as desired. As an alternative to house current, the power supply 114 could be powered by a battery or other electrical storage device.

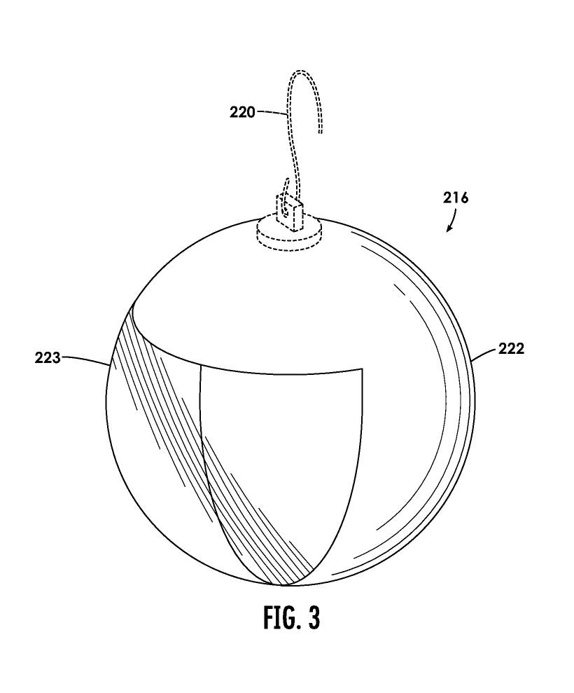

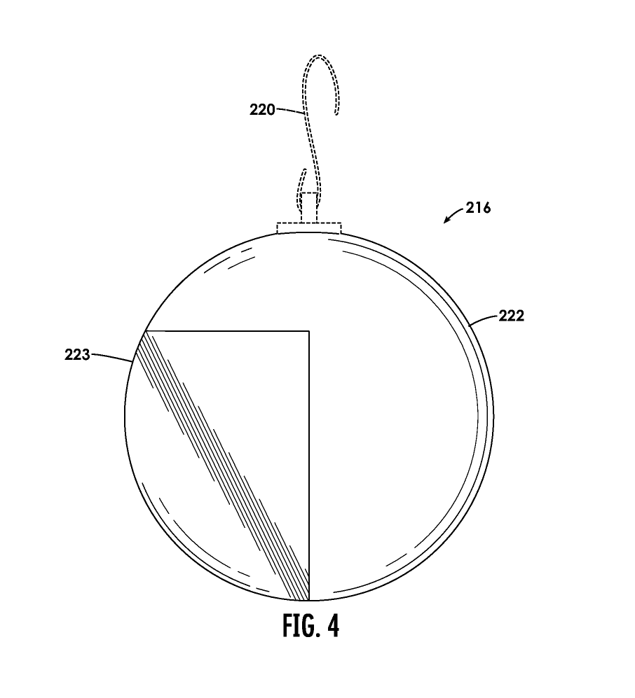

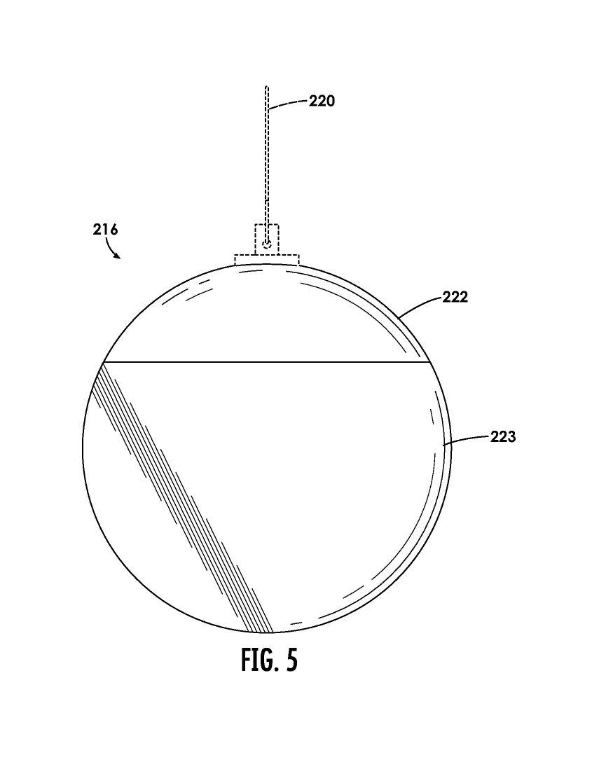

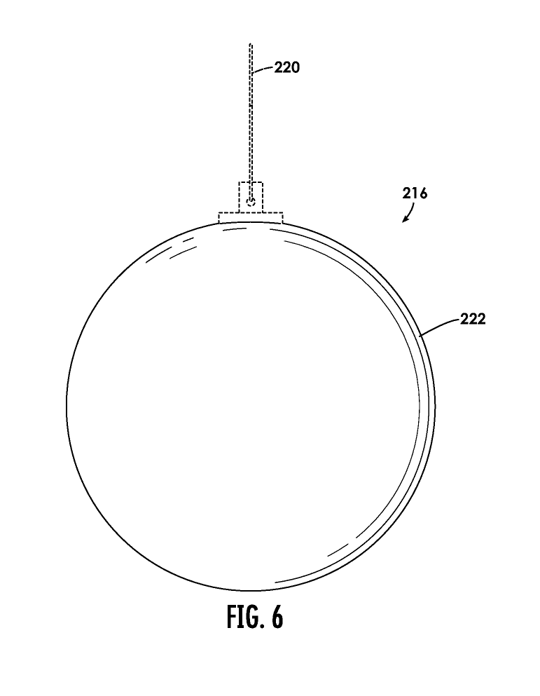

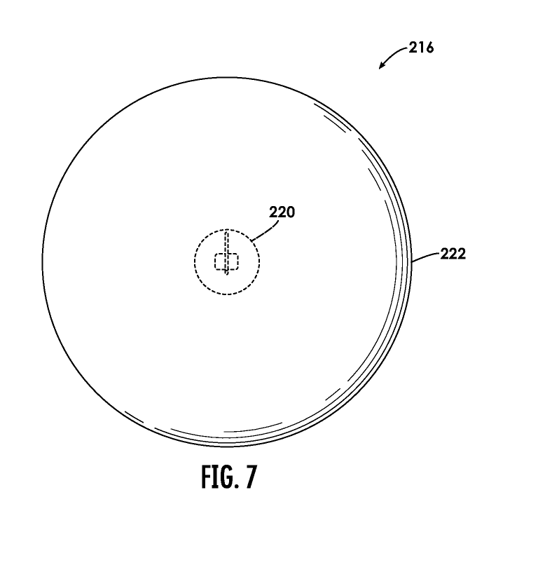

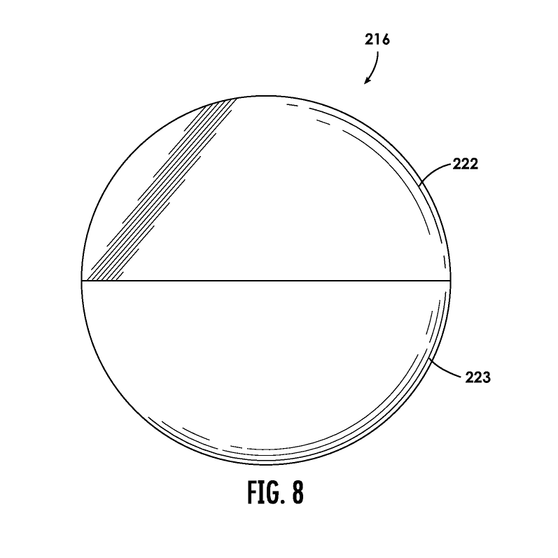

FIGS. 3-8 illustrate an ornament 216 representative of the exterior appearance of the ornaments 16 and 116 described above. The ornament 216 includes a shell with a first portion 222 that is opaque and second portion 223 that is transparent. A hologram as described above (not shown) is mounted therein and visible through the transparent second portion 223 when illuminated. A hook 220 is provided for hanging the ornament 216. The ornament 216 may be constructed as described above for the ornaments 16 or 116 and includes a light source (not shown) for illuminating the hologram.

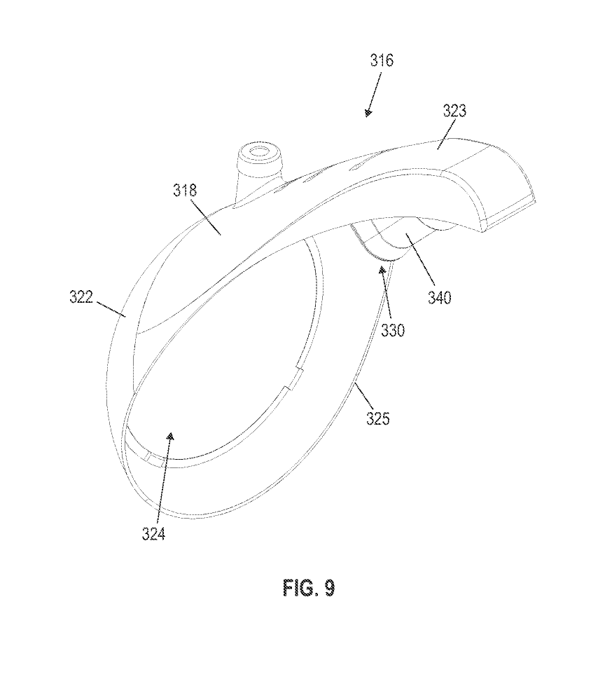

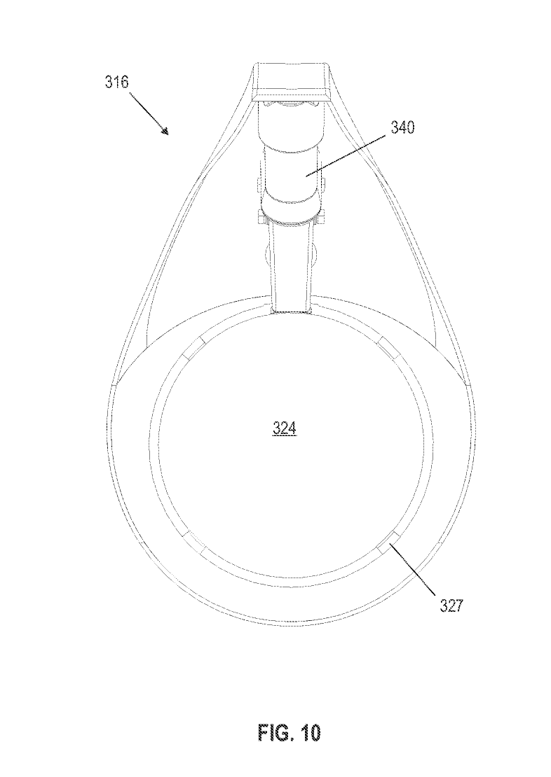

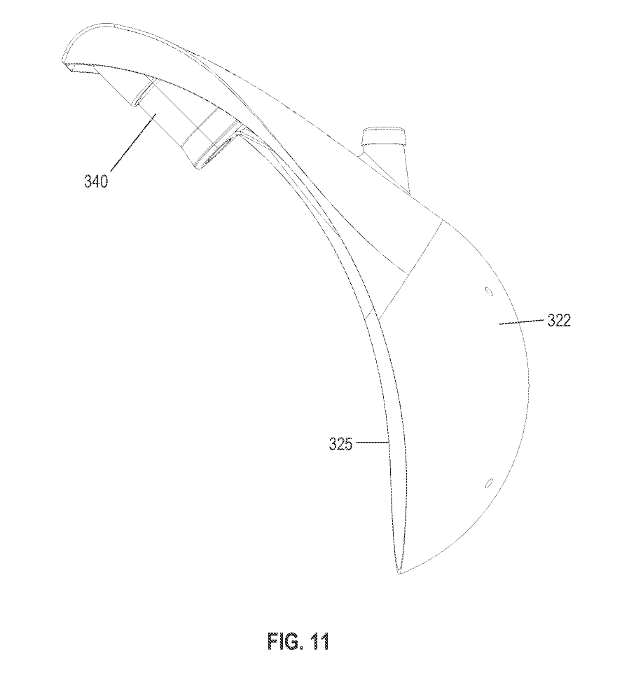

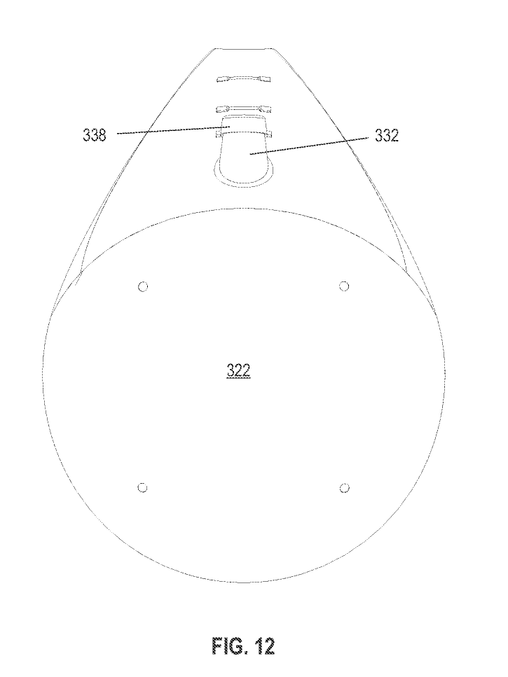

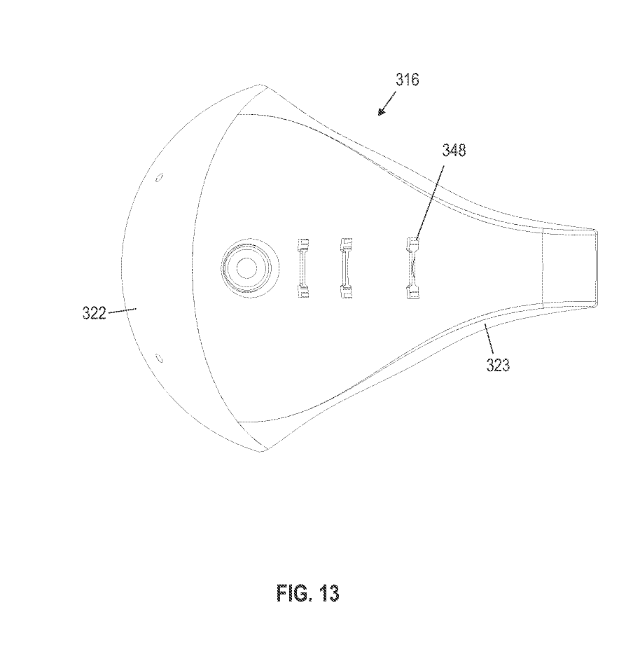

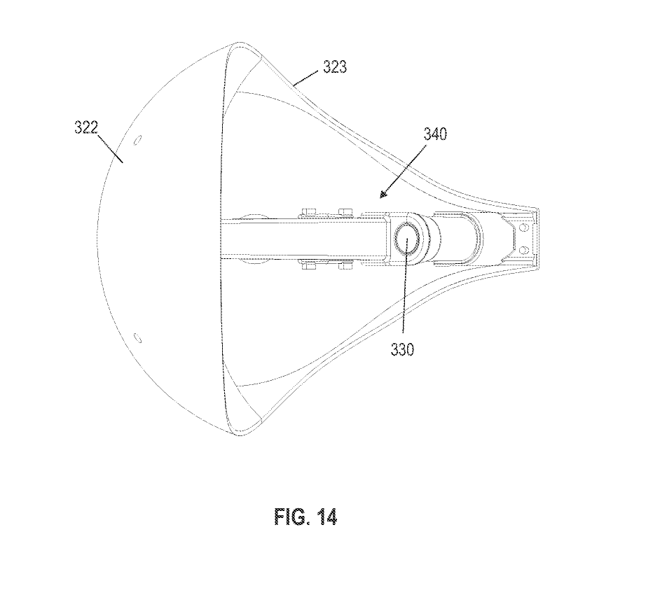

FIGS. 9-16 illustrate an alternative ornament 316 similar to the ornaments 16 and 116 described above. The ornament 316 includes a shell 318 having a rear portion 322 and a front portion 323, both of which may be transparent or opaque. The portions 322 and 323 may be manufactured separately and then joined, or they may be formed as part of a monolithic whole, through injection molding or a similar process. The rear portion 322 is generally semi-spherical in shape, and includes a surface to which a hologram 324 as described above is mounted. In the illustrated example the hologram 324 is retained by tabs 327. The front portion 323 extends forward from the top center portion of the front edge 325 of the rear portion 322. The front portion 323 is generally arcuate in front elevation view (see FIG. 10) and is generally triangular in top plan view (see FIG. 13), tapering from a width of about one-third of a circle at the front edge 325 of the rear portion 322, to a width just wide enough for a light source at its distal end.

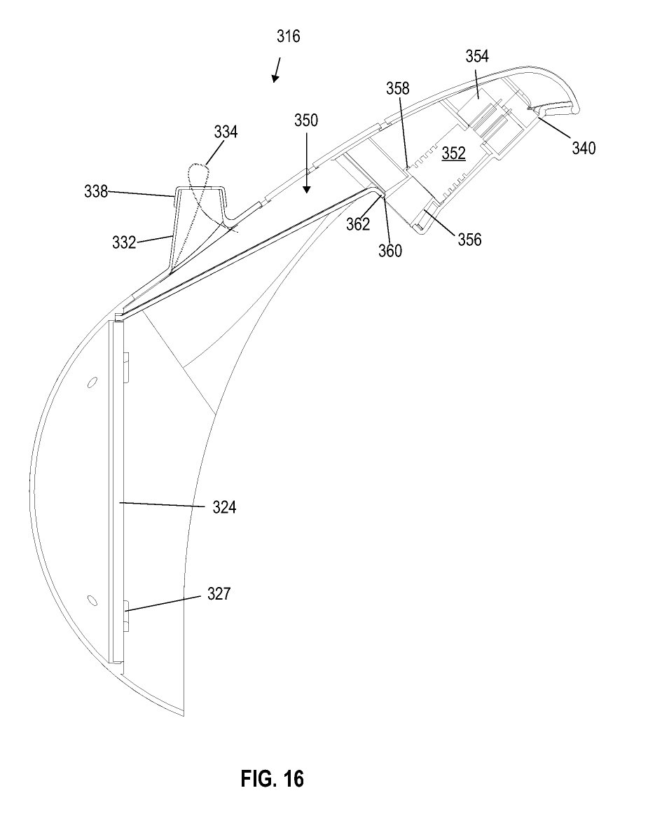

The upper portion of the shell 318 may include a tapered tubular tower 332 (see FIG. 16) which receives a conventional spring clip 334. A known type of metal wire hook (not shown) can be attached to the spring clip 334, for hanging the ornament. The tower 332 may also serve as a pass-through for power supply wires (not shown). An annular trim ring 338 may be provided to cover the exposed end of the tower 332.

A light source 330 is mounted at the distal end of the front portion 323. In the illustrated example, the light source 330 is a commercially-available white light-emitting diode (“LED”) as described above. The light source 330 may incorporate a lens configured to project light onto the hologram 324 as required. The light source 330 is positioned so as to illuminate the hologram 324 from the same direction as the source object was illuminated during creation of the hologram 324, as far as possible.

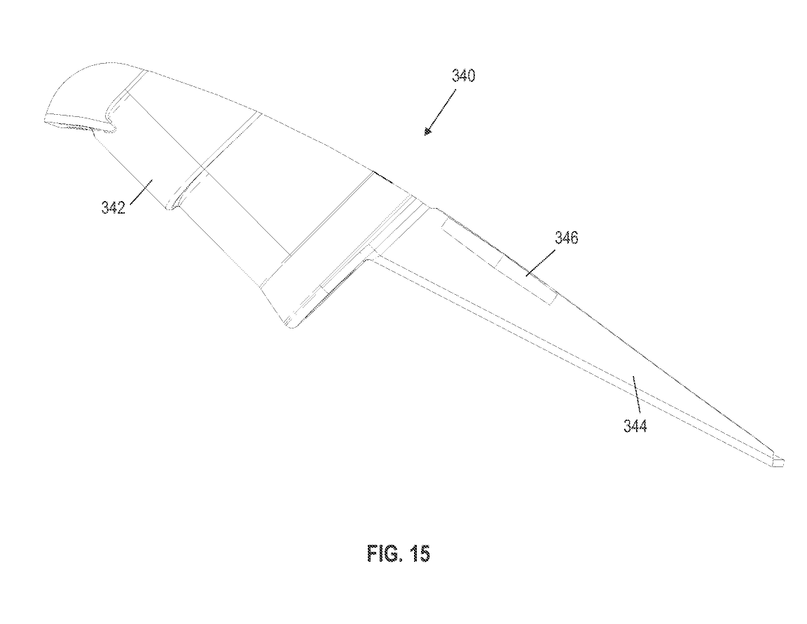

In the illustrated example, the light source 330 is contained in a light housing 340. As seen in FIG. 15, the light housing 340 is an elongated, generally U-shaped channel with front and rear portions 342, 344 respectively. It is retained to the front portion 323 of the shell 318 by tabs 346 which engage corresponding hooks 348 formed in the front portion 323. Other attachment methods such as adhesives or mechanical fasteners could be used instead of the tabs 346 and hooks 348.

As best seen in FIG. 16, the rear portion 342 of the light housing 340 forms an enclosed volume 350, in cooperation with the front portion 323 of the shell 318. This provides a space to route electrical wires (not shown) to the light source 330 and hides the spring clip 334 from view.

The front portion 344 of the light housing 340 receives and positions the light source 330. In the illustrated example, light source 330 includes an LED 352 as described above, an electrical connector block 354, and a shroud 356. The shroud 356 is a small tubular component with an inside bore 358 at one end that receives the LED 352, and an external cylindrical surface 360 at the other end that is received in a hole 362 in the light housing 340. The shroud 356 may be made from a metal alloy and serves to conduct heat away from the LED 352 in operation.

In this variation, there is no structure in front of the hologram 324, providing a clear, unobstructed view. Furthermore, there is increased flexibility to position the light source 330 as needed to optimum viewing of the hologram 324. This shell 318 may be provided with a hook for hanging as described above, and the light source 330 may be connected to a string of ornaments and a power source for the light source 330 as described above. It is noted that this shell structure may be used with a reflection hologram or a transmission hologram. If a transmission hologram is used, the rear portion 322 of the shell 318 would be made transparent and the type of light source 330 would be selected to be compatible with the transmission hologram (for example, a laser as described above could be substituted for an LED).

The foregoing has described a holographic ornament. All of the features disclosed in this specification (including any accompanying claims, abstract and drawings), and/or all of the steps of any method or process so disclosed, may be combined in any combination, except combinations where at least some of such features and/or steps are mutually exclusive. Each feature disclosed in this specification (including any accompanying claims, abstract and drawings) may be replaced by alternative features serving the same, equivalent or similar purpose, unless expressly stated otherwise. Thus, unless expressly stated otherwise, each feature disclosed is one example only of a generic series of equivalent or similar features. The invention is not restricted to the details of the foregoing embodiment(s). The invention extends to any novel one, or any novel combination, of the features disclosed in this specification (including any accompanying claims, abstract and drawings), or to any novel one, or any novel combination, of the steps of any method or process so disclosed.

What is claimed is:

1. An ornament, comprising:
a shell (18, 118, 318);
a hologram (24, 124, 324) mounted inside the shell (18, 118, 318), the hologram (24, 124, 324) comprising a substrate containing a recorded interference pattern, and having a viewing side (26, 126) and an opposed backside (28, 128); and
a light source (30, 130, 330) mounted to the shell (18, 118, 318) and positioned so as to project light onto the hologram (24, 124, 324).

2. The ornament of claim 2, wherein at least a portion of the shell (18, 118) is translucent or transparent, further comprising:
a light-blocking structure (22, 122) disposed inside the shell (18, 118) between the shell (18, 118) and the backside (28, 128) of the hologram (24, 124).

3. The ornament (18) of claim 2 wherein the hologram (24) is a reflection hologram and the light source (30 is mounted between the shell (18) and the viewing side (26) of the hologram (24).

4. The ornament (118) of claim 2 wherein the hologram (124) is a transmission hologram and the light source (130) is mounted between the shell (118) and the backside side (126) of the hologram (124).

5. The ornament of claim 2 wherein the light source (30, 130) comprises a light-emitting diode.

6. The ornament of claim 2 wherein the light source (30, 130) is located relative to the hologram (24, 124) so as to illuminate the hologram (24, 124) from the same direction as a source object of the hologram (24, 124) was illuminated during creation of the hologram (24, 124).

7. The ornament of claim 2 wherein the light source (30, 130) comprises a lens configured to project light onto the hologram (24, 124).

8. The ornament of claim 2 wherein the light-blocking structure (22, 122) is a layer of paint applied to the interior of the shell (18, 118).

9. The ornament of claim 1 wherein the shell (318) includes:
a generally semi-spherical rear portion (322) having a front edge (325), where the rear portion (322) carries the hologram (324); and
a tapering front portion (323) extending forward from the front edge (325), wherein the light source (330) is carried at a distal end of the front portion.

10. The ornament of claim 9 wherein the light source (30, 130) is contained in an elongated light housing which is attached to the front portion (323) of the shell (318).

11. The ornament of claim 10 wherein the light source (30, 130) includes an LED (352), a connector block (354), and a tubular shroud (356).

12. The ornament of claim 1 wherein the shell (18, 118, 318) includes a tubular tower (332) configured to retain a spring clip (334) therein.

13. An ornament string apparatus (10, 110) comprising:
an electrical power supply (14, 114);
a cable (12, 112) coupled to the electrical power supply; and
a plurality of ornaments (16, 116, 318) according to claim 1 spaced along the cable (12, 112), each ornament (16, 116, 318) coupled to the power supply (14, 114) through the cable (12, 112).

14. The apparatus of claim 13 wherein each ornament (16, 116, 318) is mechanically connected to the cable (12, 112).

15. The apparatus of claim 13 wherein each ornament (16, 116) is provided with a hook (20, 120) for hanging the ornament (16, 116).
